(19) United States
(12) Patent Application Publication
(10) Pub. No.: US 2010/0302550 A1
(43) Pub. Date: Dec. 2, 2010

(54) DEVICE AND METHOD FOR THE OPTICAL MEASUREMENT OF RELATIVE DISTANCES

(75) Inventors: Martin HACKER, Jena (DE); Roland BERGNER, Jena (DE); Ingo KOSCHMIEDER, Jena (DE); Rudolf Murai VON BÜNAU, Jena (DE); Gerard ANTKOWIAK, Jena (DE); Ralf EBERSBACH, Schmolln (DE); Thomas PABST, Jena (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: CARL ZEISS MEDITEC AG, Jena (DE)

(21) Appl. No.: 12/788,828

(22) Filed: May 27, 2010

(30) Foreign Application Priority Data
May 28, 2009 (DE) 102009022958.2

(51) Int. Cl. G01B 9/02

(52) U.S. Cl. 356/479

(57) ABSTRACT

An optical time domain coherence tomograph including an object beam path, a detection beam path and a detector unit. An interferometer unit, which has a first and a second beam path part having different optical path lengths, splits radiation and feeds it into the two beam path parts and superimposes it again after passage through the beam path parts and thus generates a dual beam, which has components which are axially offset to one another because of the differing optical path lengths of the two beam path parts. A scanning unit has a first adjuster and a second adjuster for adjusting the optical path length of the first and second beam path parts and the first and the second adjustment means adjusting the path length for scanning the object in coordination to one another under control by the control unit.

This application claims priority to German Patent Application No. 10 2009 022 958.2 filed on May 28, 2009, which is incorporated herein by reference in its entirety.

### BACKGROUND OF THE INVENTION

The invention relates to a device for the optical measurement of relative distances of structures of an object, which device is implemented as an optical time domain coherence tomograph, which has an object beam path, through which measuring radiation is incident on the object, a deflection beam path, which comprises a detector unit and through which sample radiation reflected or backscattered from the object reaches the detector unit, an interferometer unit, which has a first and a second beam path part having different optical path lengths, which further splits radiation and feeds it into the two beam path parts and superimposes it again after passage through the beam path parts and thus generates a dual beam, which dual beam has components axially offset to one another because of the different optical path lengths of the two beam path parts, the interferometer unit either being situated in the object beam path, so that the measuring radiation is incident on the object as a dual beam, or being situated in the detection beam path, so that the sample radiation reaches the detector unit as a dual beam, and the different optical path lengths of the beam path parts influencing the relative distance of such structures sensed on the object, whose sample radiation is capable of interference at the detector unit, a scanning unit for scanning the relative distance of the acquired structures, wherein the scanning unit is implemented to adjust the optical relative path length of the beam path parts, and a control unit, which controls the scanning unit.

Objects are understood here in particular as living objects or samples or parts thereof, such as the human eye. These objects may also be optically dispersive (cf. EP 1587415) or influence the polarization (cf. WO 02051333) in this case.

Furthermore, the invention relates to a method for the optical measurement of relative distances of structures of an object using optical time domain coherence tomography, wherein a measuring beam is directed onto the object, sample radiation reflected or backscattered from the object is detected, either the measuring radiation or the sample radiation is split into a first and a second beam part, the beam parts pass through different optical path lengths, the beam parts are then superimposed and a dual beam is generated, which has components axially offset to one another because of the different optical path lengths, the different optical path lengths influencing the relative distance of such structures acquired on the object, whose sample radiation is capable of interference at the detector unit, and wherein relative distance of the acquired structures is scanned, in that different optical path lengths are adjusted relative to one another.

A set-up which directs a dual beam onto an object is known from Hitzenberger et al., “Measurement of Corneal Thickness by Laser Doppler Interferometry”, Investigative Opthalmology & Visual Science, Volume 33, Issue 1, January 1992. A dual beam is used in the detection beam path in DE 3201801.

Short coherence interferometers, which operate using optical coherence interferometry, are known for the measurement of transparent or partially-transparent samples, such as the human eye, for example, from U.S. Pat. No. 7,400,410 or WO 2007/065670 A1. They are used for the purpose of acquiring the location and size of scattering centers inside a sample, such as miniaturized optical components or biological tissue, for example, the human eye. Reference is made to US 2006/0109477 A1 and U.S. Pat. No. 5,321,501 for an overview of the corresponding literature on coherence interferometry. These patent specifications also describe the fundamental principles of optical coherence tomography (OCT).

The principle of coherence tomography (OCT) comprises both embodiments in which imaging is performed by scanning at various locations transversely to the direction of incidence of the radiation, and also embodiments simplified in relation thereto, in which the irradiation and radiation detection are performed only along an axis which remains unchanged, thus generating axial (i.e., one-dimensional) scattering profiles. The latter embodiment corresponds in regard to the image acquisition to a so-called A-scan of ultrasound image acquisition; it is also referred to as optical coherence domain reflectometry or coherence reflectometry (OCDR) and is used for the purpose of acquiring the location and size of scattering centers inside a sample, such as the human eye (cf. US 2007081166). A variant of an imaging OCT without lateral scanning is the so-called full field OCT according to US 2008/0231807.

In this description, the term coherence tomography (OCT) is used as a generic term. It thus comprises both three-dimensional imaging and also only one-dimensional imaging in the form of OCDR.

For OCT (and its subgroup OCDR), the variants time domain coherence tomography (time domain or TD-OCD or OCDR), having path length difference adjusted for scanning, and Fourier domain coherence tomography (FD-OCT or OCDR), having fixed path length difference and analysis of spectral information, are known. The latter is further differentiated into a variant employing broadband light sources and spectrometer-based detection (spectral domain or SD-OCT or OCDR) and a variant employing swept-source light sources and broadband detectors (swept source or SS-OCT or OCDR).

In the case of coherence tomography, the axial and the lateral resolutions are largely decoupled. The axial resolution is essentially given by the coherence length of the source. In the lateral direction, the achievable resolution is given by the lateral extension of the focus or the beam waist given in the focal range. The scattering signal of a location is thus the superposition of the backscattered radiation from the smallest resolvable volume. In the case of this superposition of backscattered radiation components, destructive or constructive interference may already also occur, so-called speckles.

An application which is of particular interest for OCDR is the length measurement in the eye. Known methods for measurement of distances or axial length operate along the axis of vision of an eye, thus, for example, the device IOL Master developed and sold by Carl Zeiss Meditec AG, whose design is also the subject matter of the patent specification U.S. Pat. No. 6,779,891.

The time domain OCDR system described in U.S. Pat. No. 6,779,891 uses a so-called dual beam approach. Instead of an independent reference beam path, as is described, for example, in EP 581871, the measuring object, the eye in the case of the IOL Master, is illuminated using a dual beam, which has components axially offset relative to one another. This dual beam is generated using an interferometer configuration. The dual beam principle is distinguished by extensive suppression of artifacts which may arise through axial object movements. Relative distances of structures in the eye are acquired, i.e., the dual beam principle provides a statement about the location of backscattering or back-reflecting structures of the object to one another. Referencing is typically performed to a special structure of the sample. In the case of opthalmology, the corneal front face is typically used, which is also obvious in the case of the axial length measurement of the eye.

The dual beam principle is relatively insensitive to axial movements of the object, but it does not compensate for lateral object shifts. If such shifts are a concern or are even unavoidable, as in the field of opthalmology, the most rapid possible measurements are sought in order to keep the influence of lateral object movements as small as possible. This is also advantageous in the case of high-precision measurements, in order to avoid resolution losses through pulsations on the eye (cf. Schmetterer et al., “Topical measurement of fundus pulsations”, Opt. Eng. 34, 711-716, 1995) or to be able to measure axial length measurement including the pulsation effects. In the case of time domain coherence tomography (or its subgroup TD-OCDR), the most rapid possible adjustment of the path length difference between the axial components of the dual beam or the most rapid possible adjustment of the length of the reference beam path is thus desirable.

Rapidly adjustable delay lines are known, for example, in U.S. Pat. No. 6,243,191, U.S. Pat. No. 6,654,127, U.S. Pat. No. 7,227,646, or the publication by M. Hasegawa et al., “Development of high speed and deep scanning optical coherence tomography system”, (IEEE Lasers and Electro-Optics, 2003; CLEO/Pacific Rim 2003; The 5th Pacific Rim Conference; Volume 1, Issue 15-19 Dec. 2003, page 305).

Dual beam methods are also known from U.S. Pat. No. 6,788,421 and DE 102007046507. A sample reflection is used as the interferometry reference signal therein. However, two spatially separate measuring beams are incident on the eye. A double passage occurs through separate delayed beam paths. In particular in the construction of U.S. Pat. No. 6,788,421, the use of partially reflective beam splitters is necessary, which attenuate the backscattered radiation components to be detected, even before the interfering superposition. Furthermore, it is disadvantageous in the concept of DE 102007046507 that the separate measuring beams cannot be oriented exactly co-linearly, because of which spacing along a measuring axis is difficult therein.

For the purpose of spacing, the use of two independent Michelson interferometers is known from Wang et al., “A low coherence “white light” interferometric sensor for eye length measurement”, Review of Scientific Instruments 66 (12); 5464-5468, in each of which interferometers an adjustment means and a detector for the location determination of a surface in the eye is used. It is thus not a dual beam method which would use interference of light backscattered on both surfaces.

### SUMMARY OF THE INVENTION

The invention is based on the object of refining a device for the optical measurement of relative distances of structures of an object and/or a corresponding method of the type cited at the beginning so that the measuring speed is increased in relation to the prior art. For this purpose, in particular the advantages of the dual beam approach for achieving a high-precision axial length measurement with insensitivity in relation to axial sample movements are to be maintained.

This object is achieved according to the invention in the case of a device of the type cited above in that the scanning unit has a first adjustment means for adjusting the optical path length of the first beam path part and a second adjustment means for adjusting the optical path length of the second beam path part and the first and the second adjustment means adjust the path lengths for the scanning of the object in synchronized manner under control by the control unit so that the coordinated adjustments define the covered range of the relative distances.

The object is further achieved by a method of the type cited above in which both the path length of the first beam part and also the path length of the second beam part are adjusted in synchronized manner, so that the coordinated adjustments define the covered range of the relative distances of the structures acquired on the object.

According to the invention, the coherence tomograph has an interferometer unit, which generates the dual beam of the dual beam method. A dual beam is understood according to the definition given above as a beam which has two components axially offset (i.e., optically delayed) to one another, which are otherwise capable of interference. If such a dual beam is reflected on an object, which has two partially reflective or backscattering structures, which are spaced apart axially by half of the amount of the axial offset or the optical path, corrected by the index of refraction, of the components of the dual beam, interference occurs in the back-reflected or backscattered sample beam within the time coherence length, because the axial offset is sufficiently canceled out by the back-reflection or backscattering. The so-called dual beam approach in coherence tomography uses this principle. The interference indicates that two structures are spaced apart from one another in the object by half of the distance of the axial offset of the components of the dual beam. If it is additionally known, as in the field of opthalmology, which structure is the reference (such as the corneal anterior face here), one automatically has an absolute reference specification about the relative location of the other structure (such as the retina) in relation to the reference.

Radiation can, of course, only interfere within a coherence volume which results as the product of the time coherence length of the radiation and the speed of light. The precision of the relative specification is thus a function of the time coherence length of the radiation used. Therefore, efforts are made to use short coherence radiation as much as possible in short coherence tomography (or its subgroup OCDR). This is understood here as radiation whose coherence length is established suitably for the desired resolution Δz for structure distances, e.g., via the selection of the spectral bandwidth of the radiation Δλ=2 ln(2) λ²/(πΔz) at the central wavelength λ (cf. Fercher et al., “Optical coherence tomography-principles and applications”, Rep. Prog. Phys. 66 (2003) 239-303). Radiation is preferably used whose coherence length is approximately equal to or one-tenth of the desired measurement resolution. Typical measurement resolutions are 3-30 μm in opthalmology. However, methods are also known in which measurement resolutions significantly below the spatial coherence length may sometimes be achieved, for example, by regression methods (fit of the axial point-spread function, PSF) or phase-sensitive measurements (cf. WO 03052345 A1). The coherence length can thus be understood as a window around twice the axial distance of the offset of the components in the dual beam, within which window a back-reflecting or backscattering structure results in interference in the sample beam. In other words, the coherence window corresponds to the boundary of the maximum optical relative delay of two radiation components, up to which noticeable interference can still occur.

For the best possible interference capability of the dual beam components to be measured at the detector, the best possible equalization of their polarization states is preferably also to be sought, but in any case an avoidance of orthogonal polarization states, which are not capable of interference (for example, horizontal and vertical polarization or right and left circular polarization). Deviations in the polarization states of the dual beam components may result through differing double refraction or polarization rotations along the particular covered optical paths of these radiation components, e.g., as a result of curved optical waveguides in interferometer arms or also through polarization-changing samples. For example, for the measuring radiation components which traverse the cornea of an eye, a polarization-changing influence is to be expected through the double refraction of the eye.

The generation of the dual beam is performed in the device according to the invention using an interferometer unit or by interferometry in the method according to the invention. It is both possible to implement the measuring radiation incident on the object as a dual beam, and also to reshape the returning sample radiation into the dual beam. In the first case, one refers to a pre-interferometer, in the second case to a post-interferometer. U.S. Pat. No. 6,779,891 describes the case of a pre-interferometer. Both approaches are within in the scope of this invention.

The adjustment of the dual beam with respect to the axial offset of the radiation components in the dual beam determines the relative distance of the structures from which interference can occur. The interferometer sweeping or relative adjustment of the path lengths of the beam parts of the interferometer thus sweeps the relative distance of the acquired structures.

The invention achieves a significant shortening of measuring time in that a beam path part or beam part is not adjusted with respect to the optical path length, as in the prior art, but rather both beam path parts or beam parts are adjusted in synchronized manner. Significant acceleration of the measurement is achieved using this approach.

In addition to the direct speed increase, in embodiments, the invention provides the use of known statistical distributions of biometric variables, in order to achieve an acceleration of the measuring procedures on average; for example, in that small measuring ranges are measured in sequence in accordance with an incidence distribution of the measuring variable to be measured until the measuring result has been obtained.

In an embodiment, the invention provides that signal-interfering effects introduced by individual adjustment elements, such as the chromatic dispersion (wavelength-dependent optical delay) in notable glass paths of rotational prisms or rotating glass cubes, are eliminated with little effort. The use of two preferably identical adjustment means in various interferometer arms also causes compensation with little effort of the chromatic dispersion caused by the adjustment means, i.e., a minimization of the dispersion difference caused in the interferometer arms. If a dispersion compensation is nonetheless necessary, optical components having different ratios between group speed index and dispersion are preferably used in the interferometer arms, for example, different fiber types in the interferometer arms (cf. U.S. Pat. No. 7,330,270). In a refinement, a residual dispersion difference is additionally set between the interferometer arms, for example, to compensate for dispersion differences between the dual beam components backscattered or back-reflected at various sample zones. The shorter interferometer arm is to have the higher dispersion for this purpose, because the dual beam component corresponding thereto covers the greater pathway in the dispersive sample, before it can interfere with the other dual beam component.

The invention uses a path length adjustment for the beam parts in the case of the interferometric generation of the dual beam and/or for the beam path parts in the respective interferometer. Such a path length adjustment is also referred to in the prior art as an adjustable delay line (optical delay line). The terms delay and adjustment are interchangeable in the meaning of this description. A plurality of delay lines are known for the adjustment of the optical path lengths in the prior art. The invention achieves an acceleration in relation to all known or future delay lines.

Furthermore, delay lines or adjustment means may now be used which were desirably rapid up to this point for specific measuring tasks, for example, in the field of opthalmology, but could not be used because of an excessively small adjustment travel. Therefore, in one variant, the invention uses adjustment means which are short-travel per se, but are very rapid, for one beam part or beam path part and a very much slower adjustment means operating in discrete adjustment steps for the other beam part or in the other beam path part. This discretely operating adjustment means predefines the individual measuring ranges, within which very rapid measurement is performed using the other adjustment mechanism, which operate continuously and comparatively more rapidly. This approach is of interest in particular if various subareas are to be sensed in an object. In the field of opthalmology, this is the case upon the acquisition of biometry data for an intra-ocular lens adaptation in the context of a cataract operation. Specifications about the axial length of the eye are required here, as well as further detail specifications, such as anterior chamber depth or corneal thickness.

An addition of the operating speeds of known adjustment means for the optical path length is achieved if the first adjustment means is operated to shorten the optical path length and the second adjustment means is operated to lengthen the optical path length. This coordinated cooperation delay means achieves, for example, in the case of identically acting adjustment means, a doubling of the adjustment speed in relation to a set-up having only one adjustment means.

Adjustment means which contribute to a low measuring time operating particularly rapidly are preferred for the invention, such as fiber stretchers (cf. U.S. Pat. No. 4,609,871), lattice-based adjustment means (rapid-scanning optical delay lines, cf. WO 02071117 A3), helicoid reflectors (cf. U.S. Pat. No. 5,907,423), stepped reflectors (cf. WO 2005033624 A1), piezoelectric and electromagnetic translationally moved reflectors, and rotational reflectors (cf. Xinan et al., “Fast-scanning auto correlator with 1-ns scanning range for characterization of mode-locked ion lasers”, Rev. Sci. Instr. 59 (9), 1988). Further adjustment means come into consideration in particular, such as those described in U.S. Pat. No. 6,343,191 and DE 10005696 A1, the above-mentioned publication of Hasegawa et al., U.S. Pat. No. 7,227,646, or U.S. Pat. No. 6,654,127. The content of the disclosure of all these publications is thus expressly incorporated by reference in this regard.

It has been shown in the prior art that a particularly rapid adjustment can be achieved using a rotating disc which has reflectors, the optical path length being a function of the rotational position of the disc.

The above-mentioned opposing adjustment of the optical path lengths can be achieved particularly advantageously using an apparatus which adjusts both path lengths simultaneously. The apparatus can be implemented in such a manner that the rotating disc carries multiple retroreflectors, which each reflect back radiation, which is incident within a sector lying around a main reflection axis along a direction of incidence, wherein the back-reflection occurs parallel to the direction of incidence and offset to the direction of incidence, and wherein the retroreflectors are combined to multiple opposing reflecting retroreflector pairs and the retroreflector pairs are attached to the disc so that the main reflection axes are tangential to the rotating disc, the beam path parts irradiating the radiation on the retroreflectors tangentially and opposite to the disc and a terminal mirror being mounted fixed for each beam path part outside the disc, which reflects the radiation reflected back by one of the retroreflectors parallel to the direction of incidence and offset to the direction of incidence back to the particular retroreflector, so that the first and the second adjustment means are formed by the rotating disc having the retroreflectors and the terminal mirror. The prisms belonging to one prism pair may also be mounted on various sides of the disc, which offers savings in space and greater positioning freedom.

However, it is to be expressly noted that the invention is not restricted to adjustment means which use rotational means. The invention also achieves an acceleration of the measurement by using typical linear displacements, as are described, for example, in above-mentioned U.S. Pat. No. 6,779,891, or also by the use of fiber stretchers.

Furthermore, in an advantageous embodiment, the invention controls the two adjustments in a signal-dependent manner, i.e., as a function of the detected signal. This makes it easier to find desired structures or to set favorable scanning ranges for averaging, which improves the signal-to-noise ratio. Optionally, different sweep speeds for the path length changes in the beam (path) parts are used by the two independently operable adjustment means, which are operated in coordinated manner, so that in the case of repeated measurements, specific relative delays occur for different positions of the adjustment means. Systematic disturbances in the adjustment means are reduced if one averages over the identical relative displacements or distances then predefined in the case of different adjustment means positions.

Because in many cases the adjustment means do not implement uniform adjustment of the path lengths, but rather sinusoidal oscillations, for example, the use of a path and/or speed measurement is advantageous in order to sense the adjustment path of the relative distances and thus achieve a correction of the depth profiles thus set. Suitable measuring units may be based on electrical, magnetic, electromagnetic, or optical principles. Examples to be listed are: capacitive, inductive, resistive, or magnetic measurements (Hall sensors), optical or magnetic coding (encoder), incremental transmitters (cf. U.S. Pat. No. 5,719,673), differential measurements, position measurement, triangulation measurements (for example, using reflective couplers), and also interferometric measurements, for example, by counting interference modulations. For this purpose, the signal radiation itself can be used for the speed determination in the relevant parts of the adjustment path (cf. DE 19810980), but alternatively also long coherent radiation of a narrowband laser diode can additionally be coupled into the interferometer and its interferences can be detected and analyzed over the entire adjustment path. Speed and location measuring units in connection with suitable controls are particularly also suitable for the coordinated operation of multiple adjustment unit. Alternatively, mechanical couplings also come into consideration for this purpose.

The interferometer unit generation of the dual beam can employ any suitable interferometer principle, in particular a Michelson construction or a Mach-Zehnder construction. For this purpose, the latter has the advantage in particular of operation free of back-reflection, which particularly saves the use of optical isolators for protecting the light source in the case of use in a pre-interferometer. If the light source contains a light amplifier (for example, in the case of lasers or super luminescent diodes, for example), back reflections into the source are problematic in particular.

When method steps or features relating to a method have been or are explained in this description, it can also be provided for the device explained that the control unit is implemented in such a manner that it causes an operation which realizes these method steps or features in the device and/or a corresponding function. Vice versa, a described functional feature or an explained mode of operation of the device is also usable as a corresponding method step or corresponding method feature for the described method.

When reference has been made to prior publications in this description with respect to individual aspects, principles, and/or elements, they are incorporated herein in their entirety by reference.

It is obvious that the above-mentioned features and the features to be explained hereafter are usable not only in the specified combinations, but rather also another combinations or alone without leaving the scope of the present invention.

### BRIEF DESCRIPTION OF THE DRAWINGS

The invention is explained in greater detail hereafter for exemplary purposes on the basis of the appended drawings, which also disclose features essential to the invention. In the figures:

FIG. 1 shows a schematic illustration of an embodiment of an interferometer for the measurement of relative distances on the eye,

FIG. 2 shows a further embodiment of a device similar to that of FIG. 1,

FIG. 3 shows a further embodiment similar to that of FIG. 1, a wheel having double prisms being used for a path length adjustment mechanism,

FIG. 4 shows a construction similar to that of FIG. 1, two adjustment mechanisms operating according to different principles being provided,

FIGS. 5a and b show possible mechanisms for the path length adjustment for one of the interferometers described here,

FIG. 6 shows a fiber-optic implementation of an interferometer similar to that of FIG. 1,

FIG. 7 shows a refinement of the interferometer of FIG. 6,

FIG. 8 shows a schematic view of an interferometer for the relative distance measurement on the eye, a post-interferometer being used, in contrast to the construction of FIG. 1,

FIG. 9 shows an alteration of the interferometer of FIG. 7, which focuses the measuring radiation simultaneously in different areas of the sample.

### DETAILED DESCRIPTION OF THE DRAWINGS

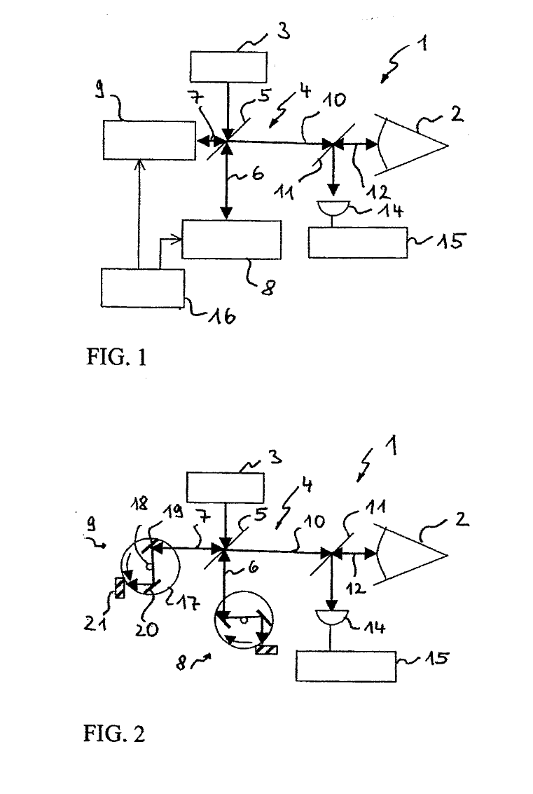

FIG. 1 shows an optical coherence tomograph (OCT), which is adapted to perform reflectometry. It is referred to hereafter as OCT 1. The OCT 1 described as an example is used for measuring lengths on an eye 2. Of course, however, other distance or length measurements on at least partially transparent objects are also possible. It is provided for time domain coherence tomography and has a source 3 suitable for this purpose as the radiation source. Multimode laser diodes or broadband super luminescent diodes would be suitable for axial length measurements, for example. The radiation has a wavelength which ensures a sufficient transmission in the sample regions to be acquired. For example, for axial length measurement on the eye, the water transmission windows around 810 nm and 1060 nm (i.e., 700-920 nm and 1020-1100 nm) are usable. For measurements in the area of the anterior chamber of the eye, i.e., for example, to determine the anterior chamber depth, radiation around 1300 nm is also suitable. In the case of sources having discrete modes, the mode intervals must be sufficiently small that for spaced structures no ambiguities occur through aliasing effects. The required bandwidth is determined by the desired depth resolution via the above-mentioned relationship.

In a Michelson interferometer 4 the radiation of the source 3 is converted into a dual beam, which has the radiation of the source 3 in two components, which are offset to one another in the radiation direction, i.e., axially, and are thus optically delayed to one another.

In the construction of FIG. 1 the Michelson interferometer 4 is used to generate this dual beam, which interferometer has a beam splitter 5, which divides the radiation of the source 3 into two beam path parts 6, 7. Each beam path part comprises a delay line, which delays the propagation of the part of the radiation of the source 3 introduced into the beam path. One delay line 8 is provided for the beam path part 6 and one delay line 9 is provided for the beam path part 7.

The delay lines 8, 9 cause a differing delay of the radiation supplied thereto, and the radiation is conducted back to the beam splitter 5 in the particular beam path 6, 7, where the radiation from the beam path parts is superimposed again. As a result, after the beam splitter 5, which then acts as a combiner, a measuring radiation 10 is provided, which is the described dual beam. This measuring radiation is directed onto the object, in this case the eye 2, by a further beam splitter 11. Structures in the eye 2 back-reflect or backscatter the measuring radiation, so that sample radiation 12 returns from the eye 2. It is coupled out at the beam splitter 11 to a detector unit, which comprises a photoreceiver 14 and an amplifier 15, which prepares the signals of the photoreceiver. The signals at the output of this amplifier 15 are analyzed in an analysis unit (not shown here for the sake of clarity) with incorporation of the instantaneous setting of the adjustment means 8 and 9 with respect to spacing of structures to be measured and optionally also displayed as a depth-resolved scattering profile (A scan). The instantaneous locations of the adjustment means may be measured for this purpose using measuring units (not shown here, but previously explained), or determined from the control signals of the control unit 16.

As already previously explained in the general part of the description, interference occurs in the sample radiation 12 if structures are present in the eye 2 which have a distance along the direction of incidence of the measuring radiation 10 which corresponds to half of the axial offset of the components in the dual beam. This distance parameter applies within the coherence length of the radiation of the source 3, of course, which therefore determines the axial resolution.

In order to adjust the relative distance in which structures are sensed in this way and thus to record a depth profile of the sample, the delay lines 8, 9 are adjustable with respect to their optical path length. They are controlled accordingly by a control unit 16.

Rapid adjustment is achieved in one embodiment of the invention in that the delay lines 8, 9 are driven in opposite directions. For example, when the delay line 8 lengthens the optical path length of the beam path 6, the delay line 9 simultaneously shortens the optical path length of the beam path part 7. The path length difference and thus the axial offset of the components in the dual beam thus varies with the sum of the adjustment speeds of the delay lines 8, 9. A measuring speed is achieved in this way, which is significantly above the speed at which the delay lines 8, 9 may be adjusted. Furthermore, the adjustment range is greater than that of one of the delay lines 8, 9. The total adjustment range is also added up from the individual adjustment ranges of the delay lines 8, 9. An eye length measurement can thus be achieved at higher speed using delay lines which would each alone not allow an acquisition of the eye length, which is typically between 22 and 25 mm.

The delay lines function as the settable adjustment means for the optical path length. An opposing action of these adjustment means is not the only advantageous way of operating the adjustment means or delay lines so they are adapted to one another. Alternatives thereto will be discussed hereafter.

FIG. 2 shows an example of adjustment means working in opposition. In FIG. 2, elements which functionally or structurally correspond to elements already explained on the basis of FIG. 1 are provided with the same reference numerals as in FIG. 1. The description is therefore not repeated once again here. Of course, this applies not only for FIGS. 1 and 2, but rather also for all further figures, in which functionally or structurally corresponding components are provided throughout with the same reference numerals. This purely reflective operating embodiment has the advantage of a lack of disturbance which could result from glass path propagations, such as dispersion, absorption, or reflection on glass entry faces.

In FIG. 2, the delay lines 8, 9 are each replaced by the construction known from U.S. Pat. No. 6,243,191, which has rotating delay lines, which are formed on a turntable 17, which can also be understood to be a disc. For this purpose, mirrors 19, 20 parallel to the rotational axis are located on the turntable 17, which are situated so that the incident radiation is first deflected by the mirror 19 lying at the edge of the turntable to the mirror 20 lying at the opposite edge and from there to a terminal mirror 21. The terminal mirror 21 reflects the radiation back on the same path. While the path length between the mirrors 19, 20 is constant (it is predefined by the distance of the two mirrors from the rotational axis 18), the total path length is influenced by the rotational position of the turntable 17. Depending on the rotational position, the path length from the beam splitter 5 to the mirror 19 or from the mirror 20 to the terminal 21 is lengthened or shortened. If the turntable 17 is rotated, a repetition of lengthening or shortening actions of the optical path lengths results, depending on the rotational direction. The turntable 17 rotates counterclockwise in the illustration of FIG. 2, which results in a repeating lengthening of the optical path length in the delay line 9. A clockwise rotation of the same construction results in an opposing shortening of the optical path length in the delay line 9. A rotation of the turntable 17 in the delay lines 8, 9, which are adapted to one another, i.e., synchronized, thus achieves a diametrically opposing adjustment of the delay lines having the described advantages. The synchronization can be performed by an electronic controller or also mechanically, for example, using suitable, low-play gearwheels for implementing a counter rotation of the turntable.

Replacing the mirror 19 and optionally the mirror 20 with a retroreflective prism, such as a triple prism, is also known for adjustable delay lines in the prior art. For this purpose, reference is made to U.S. Pat. No. 7,227,646, which is incorporated in its entirety in this context, or the above-mentioned publication of Hasegawa et al.

The beam guiding is implemented by bulk optics in FIGS. 1 and 2. Of course, fiber optics may also be used. The change between bulk optics and fiber optics is known to one skilled in the art, so that all constructions described here on the basis of bulk optics may also be implemented completely or partially using fiber optics and vice versa.

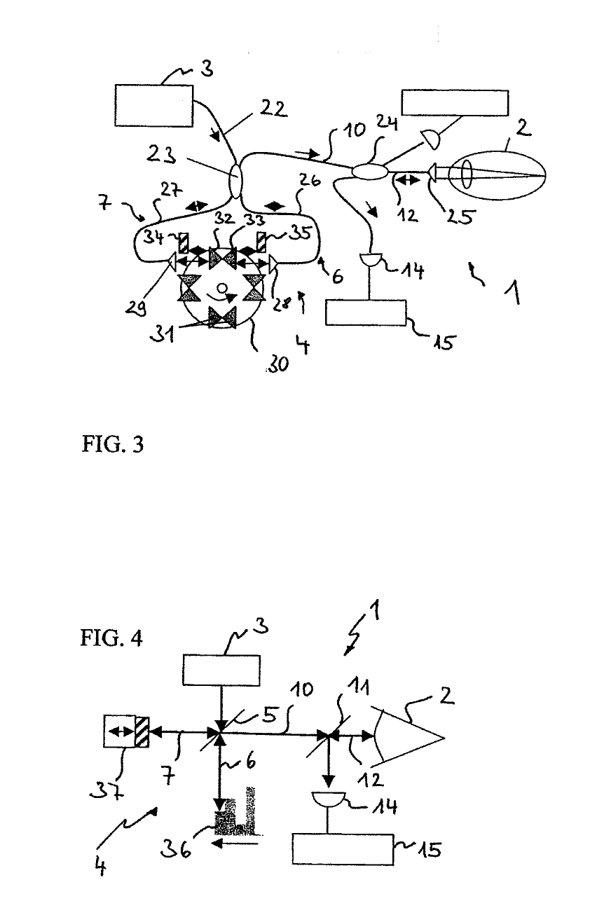

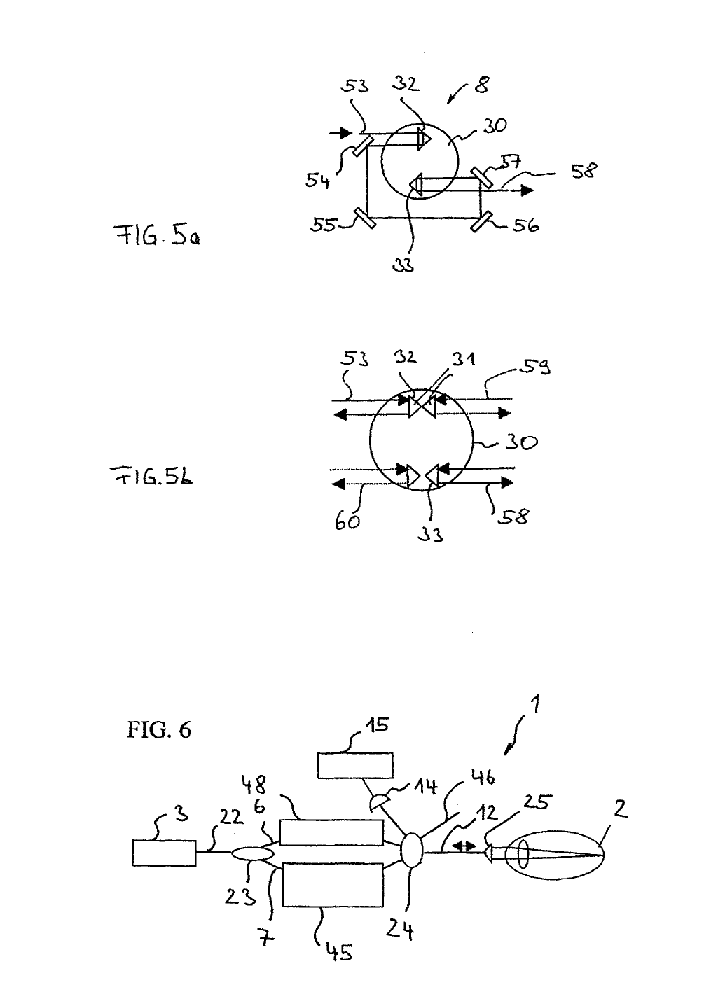

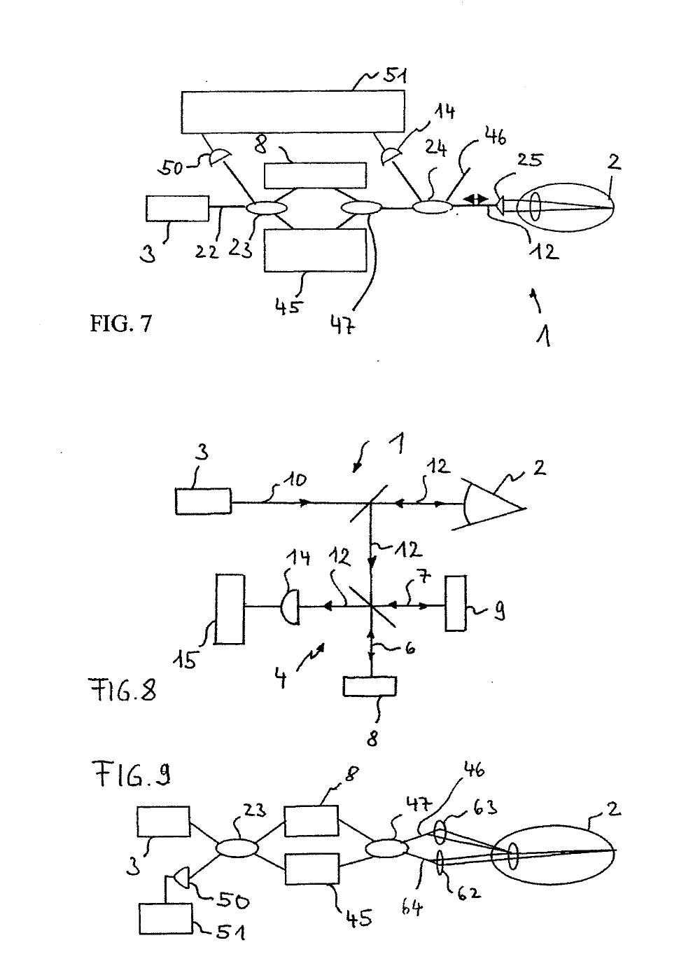

FIG. 3 schematically shows, in a fiber-optic implementation as an example here, an OCT 1, in which the adjustment means for the opposing path length adjustment in the beam path parts 6, 7 are implemented by a component which displays a combination action. The radiation of the source 3 is guided through an optical fiber 22 to a fiber coupler 23, which has the function of the beam splitter 5 of FIGS. 1 and 2. Optical fibers 26 and 27 guide the radiation into the beam path parts 6 and 7, respectively. The radiation components, which are accordingly delayed differently in the beam path parts 6, 7, are then conducted by the fiber coupler 23 (at least partially) via an optical fiber (not identified in greater detail) as the measuring radiation 10, which is implemented as a dual beam, to a fiber coupler 24, which has the function of the beam splitter 11. The measuring radiation thus reaches the eye 2 via a collimator 25 and/or the sample radiation 12 is absorbed again and conducted via the fiber coupler 24 to the photo receiver 14. In addition (not identified in greater detail), it is also shown in FIG. 3 that a fourth output of the fiber coupler 24 is conducted to a further photoreceiver feeding electronics. This output is used for control purposes, for example, for signal scaling or for the implementation of a protective unit, which is required for medical devices, to ensure radiation limiting values through suitable control of the light source.

The delay lines of the beam path parts 6 and 7 are implemented in the construction of FIG. 3 by a combination element, which again comprises a turntable 30. A triple prism pair 31 is located on the turntable, four pairs being shown here for the sake of clarity and without restriction. The individual triple prisms 32 and 33 of each pair act in an optical path length adjustment for the beam path part 6 or 7. Thus, for example, in the beam path part 6, radiation fed in at the optical fiber 26 is conducted from a collimator 28 to the triple prism 33, which performs a retroreflection. This is understood to mean that the radiation is output again from the triple prism 33 parallel to the direction of incidence, but optionally also offset thereto. It is then incident on the terminal mirror 35, which conducts the radiation back along the incidence path to the collimator 28, from which it reaches the optical fiber 26. The second triple prism 32 of the triple prism pair has a similar effect for the second beam path part 7. Radiation fed into the optical fiber 27 there is conducted by the collimator 29 to the triple prism 32, from which it is reflected to the terminal mirror 34. The terminal mirror 34 reflects the radiation back to the collimator 29 via the triple prism 32.

A rotation of the disc 30 in the direction of the arrow shortens the optical path length for the beam path part 7 and lengthens the optical path length for the beam path part 6 by the same amount. It is essential for this purpose that the triple prisms 32, 33 each re-output radiation, inciding on the triple prism in a certain sector around a main direction of incidence, parallel to the direction of incidence of the radiation. Furthermore, the triple prisms 32, 33, situated having coincident main direction of incidence and offset to one another, are combined to form the triple prism pair 31.

Finally, the collimators 29, 28 and/or the terminal mirrors 34, 35 are oriented so that they can radiate or collect (in the case of the collimators) or collect for reflection and reflect back (in the case of the terminal mirrors) radiation inciding within the sector in which the particular triple prisms 32, 33 work. In the construction of FIG. 3, this is achieved in that the main reflection axes of the triple prism pair 31 are tangential to the rotation of the rotating disc 30. However, this is not mandatory, because other constructions are also possible. For example, the collimators 29, 28 may also provide radiation to triple prisms of various triple prism pairs, but having differing orientation of the reflection direction in relation to the tangential disc rotation direction.

Furthermore, the rotating disc 30 preferably carries multiple triple prism pairs 31, so that a rotation of the rotating disc 30 results in a repeated shortening of one beam path part with simultaneous lengthening of the other. In one rotational direction, as indicated by an arrow in FIG. 3, the beam path part 7 is shortened and the beam path part 6 is lengthened. Alternatively, an oscillating rotating disc can also be used, which carries one triple prism pair 31.

The figures do not show optional means for partial or complete polarization equalization of the sample beam components to be detected, i.e., to be brought to interference, at the detector. These means may be situated in the interferometer arms and implemented as so-called “polarization paddles”, for example, i.e., fixed or mobile polarization-changing fiber loops employing bending double refraction. Alternatively, wave plates may also be used in the free beam areas. In particular, reference is made to the possibility that a polarization state equalization between the dual beam component which is reflected directly from the cornea and the dual beam component which traverses the generally polarization-changing cornea and is backscattered by deeper structures can be performed.

The superimposed guiding of the dual beam components in the fibers 10 and 12 has the effect that polarization-optical disturbances act jointly and in the same way on both dual beam components in the fibers, in particular if the polarization states have already been equalized correspondingly upon the superposition in the coupler 23. Flexible, i.e., mobile fiber connections may thus also be used, for example, in order to implement a hand-guided axial length measuring device, similar to known ultrasonic devices (cf. DE 4235079).

FIG. 4 schematically shows a construction for the OCT 1, in which the adjustment of the beam path parts 6, 7 provide different contributions to the setting of the reflection point distance. The OCT 1 in FIG. 3 essentially corresponds to the construction of FIG. 1 or 2, but having a different implementation of the delay lines. The delay lines of the beam path part 6 is embodied as a discrete path length adjustment unit, implemented here as a stepped reflector 36 as an example, while in contrast the delay line of the beam path part 7 is embodied as a continuous path length adjustment unit, implemented here as a longitudinally oscillating mirror 37. The longitudinally oscillating mirror 37 is driven into high-frequency oscillations by an appropriate exciter, such as an electromagnet, for example, oscillations in the magnitude of 100 Hz having a stroke of 5 mm. The stepped reflector 36 can be shifted along the symbolically shown arrow and allows a measuring range changeover, as shown by the schematically indicated steps of the stepped mirror 36. The stepped mirror 36 thus causes a setting of the measuring range and/or a coarse setting of the measuring depth, in that it provides corresponding discretely settable path length differences. The maximum path length difference which can be caused on the discrete path length adjustment unit is preferably a multiple of the stoke of the continuous path length adjustment unit. This is comparatively short acting on the path length change. The two units are preferably driven synchronized so that the changeover between discrete path length changes of the stepped mirror 36 occurs at moments in which the longitudinally oscillating mirror 37 is at a reversal point. The discrete adjustment states of the adjustment elements 36 are preferably adapted to the travel of the continuously operated adjustment element 37 so that the difference between two discrete states of the adjustment element 36 is less than or equal to the maximum travel of the continuously operated adjustment element 37. As a result, a continuous coverage of the total adjustment range is achieved. Known total adjustment ranges for the biometry of human eye lengths are 14-40 mm, although more than 90% of the eye lengths are to be expected in the range of 20-28 mm.

A further synchronization of the adjustments of the adjustment elements 36 and 37 comprises the travel of the rapid, continuously operated adjustment element 37 being passed through completely at least once before a changeover of the discrete state occurs on the adjustment element 37.

Fundamentally, however, it is also possible to implement multiplex operation using a combination of a discrete element 36, which can be changed over very rapidly, and a slower adjustment of the continuous adjustment element 37, in the case of which all discrete adjustments of the adjustment element 36 are always implemented for each state of the continuous adjustment element 37.

In both variants, it is very advantageous to perform a time-saving ending of the measurement upon establishment of a sufficient or clear measuring signal, i.e., if it can be seen that no further useful information could be obtained by further adjustment of the adjustment elements 36 and 37.

The position of the stepped mirror 36 predefines the range in which the rapid adjustment of the longitudinally oscillating mirror 37, which continuously adjusts the path length, senses back-reflecting or backscattering points in the object, i.e., the eye 2. The measurement is therefore preferably performed, under control of the control unit 16 (which is not shown in FIG. 2 and hereafter for the sake of simplicity), beginning using a position of the stepped mirror 36 which corresponds to a measuring range in which a backscattering or back-reflecting point is to be expected in the object, in order to obtain a reference point for the further measurements. In the case of the measurement of human eye lengths, for example, this would be the range of 23±2 mm (see, for example, Wojciechowski et al., “Age, Gender, Biometry, Refractive Error, and the Anterior Chamber Angle among Alaskan Eskimos”, Opthalmology Volume 110, Issue 2, February 2003).

If one implements the continuous delay lines in the beam path part 7, as is the case in the example of the construction of FIG. 4, through a longitudinally oscillating mirror 37, uniform change of the optical path length is not provided (although this can also be the case with other delay lines). It is then favorable to provide a path or speed measuring unit on the delay unit, in order to execute a correction of a measured depth profile. This was already explained in greater detail in the general part of the description. A further example of a rapid and continuously adjusting delay line is the construction described in U.S. Pat. No. 6,654,127. It can also be used here, so that the content of the disclosure of this publication is incorporated herein by reference in its entirety in this regard.

FIG. 5a shows a prism wheel variant having double adjusting action, which can be used in one or both interferometer arms. An incident beam 53 is deflected at a triple prism 32 being fastened on the turntable 30 and is conducted via mirrors 54 through 57 to a triple prism 33 which is opposite in relation to the turntable axis. It exits therefrom as an outgoing beam 58. The path length is a function of the turntable position. The construction of FIG. 5a has a double adjusting action with simultaneous compensation of a beam offset as a function of rotational angle because of the symmetrical beam path. The lateral beam location at the output is thus stable, which is favorable in particular for fiber couplings.

FIG. 5b shows a combination of the principle of FIG. 5a with the principle of the turntable or the construction of FIG. 3. The incident beam 53 originates from one interferometer arm, such as the collimator 29, while in contrast the incident beam 59 (shown by dotted lines) comes from the other interferometer arm, such as the collimator 28. After a first passage through the corresponding triple prism of the double prism pair 31, the beams are guided to the particular other triple prism similarly to FIG. 5a. Beams associated with one another are shown by solid lines (in the case of one interferometer arm) or dotted lines (in the case of the other interferometer arm). As a result, one outgoing beam 58 results for one interferometer arm and one outgoing beam 60 results for the other interferometer arm.

The generation of the dual beam was described for exemplary purposes up to this point on the basis of a pre-interferometer, which is implemented as a Michelson interferometer 4. Of course, other interferometer structures are also suitable, such as a Mach-Zehnder interferometer, as is schematically shown in FIG. 6. The radiation of the source 3 is coupled into an optical fiber 22 here and split into the two beam path parts 6, 7 at a fiber coupler 23. Two delay lines 48, 45 are located therein, which do not operate purely reflectively, in contrast to the delay lines 8, 9, but rather conduct the radiation with settable delay, i.e., after passage of an optical path line having lengths settable within certain limits, to the fiber coupler 24 acting as a combiner. From there, the dual beam thus generated reaches the eye 2 via a collimator 25, returns as the sample beam 12, and is conducted by the fiber coupler 24 to the photoreceiver 14 and amplifier 15. The fully fiber-optic embodiment of the interferometer, which can be miniaturized, is particularly advantageous through the use of oppositely driven, piezoelectrically operated fiber stretchers as the adjustment elements 45 and 48.

FIG. 7 shows an OCT 1, which is similar to that of FIG. 6. However, on the one hand, a pair of 2×2 couplers 24 and 47 is used instead of the 3×3 coupler 24. A further alteration which is found in the OCT 1 of FIG. 7, but could also be used similarly with the other constructions, however, is the implementation of the amplifier 15 as a detector circuit 51, which performs a summation and/or differential measurement of the incoming radiation at the photo receiver 14 together with the signals of a photoreceiver 50, which receives a part of the radiation of the source 3 without further modification. Noise-reducing balanced detection is thus possible.

An embodiment in which the monitoring terminal 46 can be used for signal acquisition is shown in FIG. 9. The two terminals 46 and 64 of the fiber coupler 47 are coupled to optics 62 and 63, respectively, which focus on different regions of the eye 2. The sample radiation thus returning from different sections of the eye passes through the fiber coupler 47 and the delay lines 8 and 45 again and is decoupled at the fiber coupler 23 to the detector 50.

The delay lines 8 and 45 thus act, on the one hand, as a pre-interferometer and generate the dual beam at the fiber coupler 47. On the other hand, they also act as a post-interferometer for the sample radiation returning at the fiber coupler 47. A double delay is thus achieved and the measuring speed rises accordingly, because short-travel delay lines are possible. Because of the double passage, its travel is de facto doubled. Suitably rapid delay lines are the above-mentioned piezoelectric fiber stretchers, for example.

Finally, FIG. 8 schematically shows that the interferometer for generating the dual beam in the OCT 1 does not necessarily have to be designed as a pre-interferometer. It is entirely possible to have the measuring beam 10 be incident on the object, i.e., the eye 2, directly and without prior interferometric action, and instead to divide the sample beam 12 into two components by a post-interferometer so that interference again occurs at the photoreceiver 14. FIG. 8 shows a Michelson interferometer 4 for this purpose having the corresponding components as an example. Of course, the implementation of the post-interferometer is not restricted to this concrete structure, but rather all interferometer designs which come into consideration as a pre-interferometer could also be used for the post-interferometer.

The coordinated change of the optical path lengths in the beam path parts provided in all explained variants of the OCT 1, which generates the dual beam for the measuring beam 10 or from the sample radiation 12, may be used not only for accelerating the measurement. If one uses the independent delay lines having different sweeping speeds, specific relative delays result from different locations of the delay lines upon repeated measurements. This allows systematic disturbances of the delay lines, for example, as a result of mechanical deformations on delay lines or path measurement systems, to be suppressed, for example, by averaging. Of course, a suppression can also be performed in another way, for example, by suitable filtering, etc.

What is claimed is:

1. A device for the optical measurement of relative distances of structures of an object, which is implemented as an optical time domain coherence tomograph, comprising:
an object beam path, through which measuring radiation is incident on the object,
a detection beam path, which comprises a detector unit and through which sample radiation reflected or backscattered by the object reaches the detector unit,
an interferometer unit, which has a first and a second beam path part having different optical path lengths, the interferometer unit splitting sample radiation and feeding the sample radiation into the two beam path parts and superimposing the sample radiation again after the sample radiation's passage through the beam path parts and thus generating a dual beam, which has components which are axially offset to one another because of the different optical path length of the two beam path parts,
the interferometer unit either being situated in the object beam path, so that the measuring radiation is incident on the object as the dual beam, or being situated in the detection beam path, so that the sample radiation reaches the detector unit as the dual beam, and the different optical path lengths of the beam path parts influencing the sensing of relative distance of the structures the object, the sample radiation returning from the structures being capable of interference at the detector unit,
a scanning unit for scanning the relative distance of the structures, the scanning unit being implemented to adjust the optical relative path lengths of the beam path parts, and
a control unit, which drives the scanning unit,
wherein
the scanning unit includes a first adjustment means that adjusts the optical path length of the first beam path part and a second adjustment means that adjusts the optical path length of the second beam path part and
the first adjustment means and the second adjustment means adjust the path lengths for scanning the object in coordination to one another under control by the control unit, so that the coordinated adjustments jointly define a covered range of the relative distances.

2. The device according to claim 1, wherein the first adjustment means continuously adjusts the optical path length and the second adjustment means discretely adjusts the optical path length in adjustment steps, the smallest of the adjustment steps causing an adjustment of the optical path length which is not greater than an adjustment range of the continuous adjustment of the first adjustment means.

3. The device according to claim 1, wherein the control unit simultaneously controls the first adjustment means to shorten the optical path length of the first beam path part and the second adjustment means to lengthen the optical path length of the second beam path part.

4. The device according to claim 3, wherein at least one of the adjustment means comprises a rotating disc having reflectors, the optical path length being a function of the rotational position of the disc.

5. The device according to claim 3, wherein the rotating disc comprises multiple retroreflectors which each reflect back radiation, which is incident within a sector lying around a main reflection axis along a direction of incidence, parallel to the direction of incidence and offset to the direction of incidence, the retroreflectors being combined as multiple oppositely reflecting retroreflector pairs and the retroreflector pairs being attached to the disc so that the main reflection axes are tangential to the rotating disc, wherein the beam path parts irradiate the radiation tangentially and opposite to the disc and onto the retroreflectors and a terminal mirror is fixedly mounted in each beam path part outside the disc, which terminal mirror reflects the radiation, which is reflected back parallel to the direction of incidence and offset to the direction of incidence by one of the retroreflectors to the particular retroreflector again, so that the first and the second adjustment means are formed by the rotating disc having the retroreflectors and the terminal mirrors.

6. The device according to claim 1, wherein the two adjustment means further comprise position, path, and/or speed measuring units, which output a signal which represents the adjustment of the optical path length.

7. The device according to claim 1, further comprising means for the partial or complete equalization of polarization states occurring at the detector of the sample radiation components to be detected situated in the first and/or second beam path part of the interferometer unit.

8. The device according to claim 6, wherein the control unit is programmed to, in synchronization with the signals of the detection unit, record signals of the position, path, and/or speed measuring units of the adjustment means or of signals derived from such signals and analyzes them jointly to determine relative distances.

9. A method for the optical measurement of relative distances of structures of an object using optical time domain coherence tomography, comprising
directing a measuring beam onto the object,
detecting sample radiation reflected or backscattered from the object with a detection unit,
splitting either the measuring radiation or the sample radiation into a first beam part and a second beam part,
passing the beam parts through different optical path lengths,
superimposing the beam parts to generate a dual beam, which has components axially offset to one another because of the different optical path lengths,
the different optical path lengths influencing the relative distance of the structures sensed on the object, sample radiation from the structures being capable of interfering at a detector unit,
scanning a relative distance of the sensed structures by adjusting the different optical path lengths relative to one another, and
adjusting both the path length of the first beam part and the path length of the second beam part in coordinated manner, so that the coordinated adjustments define a covered range of the relative distances of the structures sensed on the object.

10. The method according to claim 9, further comprising adjusting the optical path length of the first beam part continuously and adjusting the optical path length of the second beam part in discrete adjustment steps, each adjustment step causing an adjustment of the optical path length which is not greater than an adjustment range of the continuous adjustment of the optical path length of the first beam part.

11. The method according to claim 10, further comprising shortening the optical path length of the first beam path part and lengthening the optical path length of the second beam path part simultaneously.

12. The method according to claim 9, further comprising adjusting at least one of the optical path lengths over an entire adjustment range in a non-monotonic way.

13. The method according to claim 12, wherein differences of sequential adjustments change sign multiple times during the passage through an entire adjustment range.

14. The method according to method claim 12, further comprising adjusting at least one of the optical path lengths in discrete adjustment steps; and
selecting the adjustment steps according to a known incidence distribution of a biometric variable to be measured.

15. The method according to claim 9, further comprising adjusting at least one of the path lengths as a function of signals acquired by the detection unit.

16. A device for the optical measurement of relative distances of structures of an object, which is implemented as an optical time domain coherence tomograph, comprising:
an object beam path, through which measuring radiation is incident on the object,
a detection beam path, which comprises a detector unit and through which sample radiation reflected or backscattered by the object reaches the detector unit,
an interferometer unit, which has a first and a second beam path part having different optical path lengths, the interferometer unit splitting sample radiation and feeding the sample radiation into the two beam path parts and superimposing the sample radiation again after the sample radiation's passage through the beam path parts and thus generating a dual beam, which has components which are axially offset to one another because of the different optical path length of the two beam path parts,
the interferometer unit either being situated in the object beam path, so that the measuring radiation is incident on the object as the dual beam, or being situated in the detection beam path, so that the sample radiation reaches the detector unit as the dual beam, and the different optical path lengths of the beam path parts influencing the sensing of relative distance of the structures the object, the sample radiation returning from the structures being capable of interference at the detector unit,
a scanning unit for scanning the relative distance of the structures, the scanning unit being implemented to adjust the optical relative path lengths of the beam path parts, and
a control unit, which drives the scanning unit,
wherein
the scanning unit includes a first adjuster that adjusts the optical path length of the first beam path part and a second adjuster that adjusts the optical path length of the second beam path part and
the first adjuster and the second adjuster adjust the path lengths for scanning the object in coordination to one another under control by the control unit, so that the coordinated adjustments jointly define a covered range of the relative distances.

17. The device according to claim 16, wherein the first adjuster continuously adjusts the optical path length and the second adjuster discretely adjusts the optical path length in adjustment steps, the smallest of the adjustment steps causing an adjustment of the optical path length which is not greater than an adjustment range of the continuous adjustment of the first adjuster.

18. The device according to claim 16, wherein the control unit simultaneously controls the first adjuster to shorten the optical path length of the first beam path part and the second adjuster to lengthen the optical path length of the second beam path part.

19. The device according to claim 18, wherein at least one of the adjuster comprises a rotating disc having reflectors, the optical path length being a function of the rotational position of the disc.

20. The device according to claim 18, wherein the rotating disc comprises multiple retroreflectors which each reflect back radiation, which is incident within a sector lying around a main reflection axis along a direction of incidence, parallel to the direction of incidence and offset to the direction of incidence, the retroreflectors being combined as multiple oppositely reflecting retroreflector pairs and the retroreflector pairs being attached to the disc so that the main reflection axes are tangential to the rotating disc, wherein the beam path parts irradiate the radiation tangentially and opposite to the disc and onto the retroreflectors and a terminal mirror is fixedly mounted in each beam path part outside the disc, which terminal mirror reflects the radiation, which is reflected back parallel to the direction of incidence and offset to the direction of incidence by one of the retroreflectors to the particular retroreflector again, so that the first and the second adjuster are formed by the rotating disc having the retroreflectors and the terminal mirrors.

21. The device according to claim 16, wherein the two adjuster further comprise position, path, and/or speed measuring units, which output a signal which represents the adjustment of the optical path length.

22. The device according to claim 16, further comprising partial or complete polarization equalizers that equalize the polarization states occurring at the detector of the sample radiation components to be detected situated in the first and/or second beam path part of the interferometer unit.

23. The device according to claim 21, wherein the control unit is programmed to, in synchronization with the signals of the detection unit, record signals of the position, path, and/or speed measuring units of the adjuster or of signals derived from such signals and analyzes them jointly to determine relative distances.
